(19) United States
(12) Patent Application Publication
(10) Pub. No.: US 2013/0216788 A1
(43) Pub. Date: Aug. 22, 2013

(54) Fan-Folded Cellular Cushioning Article

(71) Applicant: SEALED AIR CORPORATION (US), (US)

(72) Inventor: Rohn E. Schellenberger, Sparta, NJ (US)

(73) Assignee: SEALED AIR CORPORATION (US), Elmwood Park, NJ (US)

(21) Appl. No.: 13/770,541

(22) Filed: Feb. 19, 2013

Related U.S. Application Data
(60) Provisional application No. 61/599,588, filed on Feb. 16, 2012.

(51) Int. Cl. B32B 3/12

(52) U.S. Cl. CPC B32B 3/12
USPC 428/158

(57) ABSTRACT

A cellular cushioning article strand in fan-folded configuration has embossed film bonded to backing film with entrapped air between the films. The embossed film has 15 to 40 percent land area and 85 to 60 percent embossed area. The embossments of a first ply are nested into the embossments of a second ply, with the first and second plies having a height under 0.05 psi load corresponding with a nesting level of at least 1 percent measured against two roll-stacked plies of the same cellular cushioning article under the same load. A strand of cellular cushioning fan-folded into at least 20 plies exhibits a post-0.05 psi temporary loading nesting level of at 1 percent relative to the post-0.05 psi temporary loading height of 20 plies of the same cellular cushioning article in roll-stacked arrangement.

### FIELD

The invention disclosed herein relates to cellular cushioning articles made from embossed films adhered to backing films, with cushioning cells between the embossed film and the backing film.

### BACKGROUND

Cellular cushioning articles, such as Bubble Wrap® cellular cushioning available from Sealed Air Corporation, has been used for almost 50 years for the packaging of a wide variety of items. Cellular cushioning protects products during storage and shipment, by cushioning products during handling and transport.

Cellular cushioning is typically manufactured by thermoforming embossments on a first film and thereafter adhering a flat backing film to land areas between the embossments, thereby trapping air between the cavities of the embossments and the flat backing film. During manufacturing, a strand of cellular cushioning is formed and rolled up. The size of the rolls of air cellular cushioning is generally greater for industrial end use than for consumer end use. A roll for industrial end use can have a diameter of, for example, eight feet, whereas a roll diameter for consumer use will typically have a diameter of 12 inches or less.

Both large and small diameter rolls of cellular cushioning take up a large “cube space” in warehouses, in trucks and other shipping vehicles, on store shelving, and in consumer homes and businesses. It would be desirable to provide packages of cellular cushioning of various desired sizes, while reducing the cube space required in warehouses, during shipment, on store shelves, and in consumer homes and businesses.

### SUMMARY

Cellular cushioning articles that provide a relatively high level of cushioning protection often provide this high level of cushioning due at least in part to the embossed film having relatively low percentage of land area and a corresponding relatively high percentage of embossed area. Raising the percent land area with the resulting corresponding lowering of the percent embossed area, lowers the level of cushioning protection provided by the cellular cushioning article.

It has been discovered that it is possible to reduce the transport and storage volume of cellular cushioning articles offering a high level of cushioning protection. More particularly, it has been found that cellular cushioning articles having embossed films with a relatively low percent land area, when stacked in a nesting configuration, can undergo enough nesting to substantially lower the volume of the cellular cushioning article for transport and storage.

A first aspect is directed to a fan-folded cellular cushioning article strand comprising an embossed film having a plurality of discrete embossments separated from one another by a land area, with the land area of the embossed film being bonded to a flat backing film. Air or other gas or liquid is entrapped within closed chambers between the embossments of the embossed film and the flat backing film. The embossed film has a land area of from 15 percent to 40 percent, and an embossed area of from 85 percent to 60 percent. The cellular cushioning article strand is in a fan-fold configuration having a first ply folded against a second ply so that the embossments of the first ply are facing and directly contacting the embossments of the second ply. The first and second plies in fan-folded configuration have a total height corresponding with a nesting level of at least 1 percent measured by placing the first and second plies in fan-folded configuration under a load of 0.05 psi, relative to the height of roll-stacked first and second plies of the cellular cushioning article under the 0.05 psi load.

In an embodiment, the first and second plies in fan-folded configuration having a total height corresponding with a nesting level of at least 2 percent measured by placing the first and second plies in fan-folded configuration under a load of 0.05 psi, relative to the height of roll-stacked first and second plies of the cellular cushioning article under the 0.05 psi load. Alternatively, the nesting level under 0.05 psi load can be at least 3 percent, or at least 5 percent, or at least 10 percent, or from 2 to 45 percent, or from 3 to 35 percent, or from 5 to 25 percent, or from 10 to 20 percent.

In an embodiment, the embossed film has a land area of from 20 to 37 percent and an embossed area of from 63 percent to 80 percent. In an embodiment, the embossed film has a land area of from 25 to 35 percent and an embossed area of from 65 percent to 75 percent. In an alternative embodiment, the embossed film has a land area of about 23 percent, and an embossed area of about 77 percent.

In an embodiment, the fan-folded cellular cushioning article strand has from 10 to 500 plies; in another embodiment, from 20 to 300 plies; in another embodiment, from 30 to 100 plies; and in another embodiment, from 20 to 40 plies. The fan-folded cellular cushioning article strand can exhibit a nesting level of from 5 percent to 45 percent upon placing the first and second plies under a load of 0.05 psi as measured against the height of roll-stacked first and second sheets of the cellular cushioning article under a load of 0.05 psi.

In an embodiment, the embossments comprise a dome surface.

In an embodiment, the embossments are formed to a substantially hemispherical shape in a substantially hemispherical cavity of a forming chamber, and the embossments on the embossed film have substantially the same diameter.

In an embodiment, the embossments are arranged in a one-surrounded-by-six pattern. In an alternative embodiment, the embossments are arranged in a one-surrounded-by-four pattern.

In an embodiment, the fan-folded cellular cushioning article is in the form of a stack, and the stack is inside a packaging article. In a further embodiment, the packaging article is a member selected from the group consisting of a box, a bag, and a sleeve.

In an embodiment, at least one member selected from the group consisting of the embossed film and the backing film are perforated along lines across the strand of the cellular cushioning article strand.

In an embodiment, the embossments are arranged in rows across the strand, and adjacent rows have embossments staggered with respect to one another.

A second aspect is directed to cellular cushioning article strand in fan-folded configuration, with the cellular cushioning article comprising an embossed film having a plurality of discrete embossments separated from one another by a land area, with the land area of the embossed film being bonded to a flat backing film with air entrapped within closed chambers between the embossments of the embossed film and the flat backing film. The embossed film has a land area of from 15 percent to 40 percent, and an embossed area of from 85 percent to 60 percent. The fan-folded cellular cushioning article strand has at least 20 plies in fan-folded configuration with the embossments of the plies facing one another and being in direct contact with one another. The fan-folded cellular cushioning article exhibiting a nesting level of at least 1 percent upon an uppermost surface of the fan-folded strand being placed under a load of 0.05 psi applied for a time period of 20 seconds with the load then removed for at least 20 seconds to produce a pressed fan-folded strand, with the nesting level being determined at least 20 seconds after the load is removed by comparison of a measured height of the pressed fan-folded strand having 20 plies against a measured height of a corresponding stack of 20 individual plies of the same cellular cushioning article in roll-stacked arrangement placed under the 0.05 psi load applied for the time period of 20 seconds thereafter removed for at least 20 seconds to produce a stack of 20 pressed roll-stacked sheets.

In alternative embodiments, the fan-folded cellular cushioning article of the second aspect can exhibit a nesting level of at least 2 percent upon an uppermost surface of the fan-folded strand being placed under a load of 0.05 psi applied for a time period of 20 seconds with the load then removed for at least 20 seconds to produce a pressed fan-folded strand, with the nesting level being determined at least 20 seconds after the load is removed by comparison of a measured height of the pressed fan-folded strand having 20 plies against a measured height of a corresponding stack of 20 individual plies of the same cellular cushioning article in roll-stacked arrangement placed under the 0.05 psi load applied for the time period of 20 seconds thereafter removed for at least 20 seconds to produce a stack of 20 pressed roll-stacked sheets. Alternatively, the nesting level can be at least 3 percent, or at least 5 percent, or at least 10 percent, or from 2 to 45 percent, or from 3 to 35 percent, or from 5 to 25 percent, or from 10 to 20 percent, the nesting level being determined at least 20 seconds after the load is removed by comparison of a measured height of the pressed fan-folded strand having 20 plies against a measured height of a corresponding stack of 20 individual plies of the same cellular cushioning article in roll-stacked arrangement placed under the 0.05 psi load applied for the time period of 20 seconds thereafter removed for at least 20 seconds to produce a stack of 20 pressed roll-stacked sheets.

Alternative embodiments of the second aspect can utilize the various features of alternatives of the first embodiment, set forth above.

### BRIEF DESCRIPTION OF THE DRAWINGS

FIG. 1 is a perspective view of a cellular cushioning article in a one-surrounded-by-six pattern, illustrating the wrinkled nature of the bubbles due to reduction of air volume as the air cooled inside each of the cells.

FIG. 2 is cross-sectional view of the cellular cushioning article of FIG. 1.

FIG. 3 is a schematic representation of a single ply of a cellular cushioning article on a countertop and under a light load with wrinkles stretched out and with a corresponding uniform height, in a position for accurate measurement of the height of the single ply of the cellular cushioning article.

FIG. 4 is a cross-sectional view of two sheets of cellular cushioning article stacked in a nesting configuration, under zero load.

FIG. 5 is a schematic representation of a cellular cushioning article strand in the process of being stacked into a fan-folded configuration.

FIG. 6 is a schematic representation of a cellular cushioning article strand in fan-folded configuration.

FIG. 7 is a schematic representation of a cellular cushioning article strand in the form of a roll.

FIG. 8 is a schematic representation of a plurality of sheets of a cellular cushioning article strand in a roll-stacked configuration.

FIG. 9 is a schematic of a top view of a cellular cushioning article, illustrating the arrangement of the embossments.

FIG. 10 is a schematic representation of two strands of cellular cushioning articles, with one strand being in a roll configuration and the other strand being in fan-folded configuration.

### DETAILED DESCRIPTION

As used herein, the phrase “cellular cushioning” refers to a laminate of an embossed film (usually made by thermoforming) and a flat backing film. Cellular cushioning article are described in U.S. Pat. No. 3,616,155, which is hereby incorporated in its entirety, by reference thereto, and which discloses raised embossments on a thermo-formed film. The embossed film has a plurality of embossments each separated from the others by a “land area,” with the embossed film being bonded to the backing film throughout the land area. A gas is entrapped between the embossed portions of the embossed film and the flat backing film.

As used herein, the phrases “percent land area” and “percent embossed area” are used with reference to the percent of the “footprint” area of the embossed film, i.e., the area of a flat film having the same perimeter as the embossed film, which is the area of the embossed film before it was embossed. While the “percent land area” is the ratio of the land area to the total area before embossing multiplied by 100, the “percent embossed area” is the ratio of the bases of the embossments to the total film area before embossing, multiplied by 100. For example, if an embossed film has a perimeter sized as a 12 inches by 12 inch square, and the combined area of the footprints of the plurality of embossments on the embossed film totaled about 100 square inches, the embossed area of the embossed film would be 100 square inches, and the embossed film would be characterized as having a “percent embossed area” of about 70 percent.

The “footprint” of an embossment is the shape of the base of the embossment, i.e., the shape of the perimeter of the embossment where the embossment intersects the land area. The embossments can have any desired footprint, i.e., round, square, rectangular, pentagonal, hexagonal, trapezoid, rhomboid, irregular, etc. A round footprint is preferred because it provides the most efficient means of holding the most air within the resulting cell, i.e., the maximum volume of air within a minimum film surface. Although an infinite number of embossment designs are possible above the base of an embossment with a round footprint, various designs include: (i) embossments in the shape of a hemisphere, with no side walls, (ii) embossments having side walls in the shape of a cylinder, with a flat top or a domed top, (iii) embossments having side walls in the shape of a cone, with a flat top or a domed top, and (iv) with side walls in the shape of a cylinder or cone, with a radius at the top of the conic shaped walls leading to a flat top. As used herein, the phrase “dome surface” is used with reference to the shape of the entire embossment, as well as with reference to the shape of the top of the embossment.

As used herein the phrase “flat film” is used with respect to a film extruded from a slot die to form a film that is flat coming directly from the die, as well as a film extruded from an annular die which emerges from the die as a tubing but is thereafter slit lengthwise to form a flat film.

As used herein, the term “nesting” is used with respect to whether embossments on a first ply of cellular cushioning fit between embossments on a second ply of cellular cushioning when the plies are in face-to-face-contact with one another. Plies of the same strand can nest with one another upon folding the strand of cellular cushioning one or more times so that the plies between the fold lines are arranged with the embossments facing and in contact with one another, e.g., fan-folding. Similarly, discrete sheets of cellular cushioning can be stacked on top of one another in a manner so that the embossments of each sheet face and contact the embossments of an adjacent sheet. If the embossments of a ply or sheet face, contact, and fit between the embossments of another ply or sheet so that the thickness of the pair of plies or sheets is less than the thickness of a set of identical sheets stacked so that the embossments contact only the backing film of an adjacent sheet, then the embossments facing, contacting, and fitting between one another are considered to be in a “nesting” relationship.

As used herein, the phrase “nesting configuration” includes any arrangement of plies or sheets in which embossments of adjacent plies or sheets face and contact one another. In such arrangements, there is the potential for nesting, hence the plies or sheets are in a configuration in which nesting is at least possible.

In contrast, a set of stacked sheets of cellular cushioning in which the embossments of a sheet contact the backing film of an adjacent sheet are herein termed to be in “roll-stacked configuration.” The phrase “roll-stacked configuration” is so named because a traditional roll of air cellular cushioning inherently has the embossments of the strand contacting the backing film of an adjacent wrap on the roll. Roll-stacked sheets of cellular cushioning cannot exhibit nesting of embossments with one another because the embossments do not face one another and are not in contact with one another.

As used herein, the term “plies” is used with respect to portions of a strand of air cellular cushioning in fan-folded configuration. For example, if a strand 48 inches long is folded transversely every 12 inches and placed in fan-folded configuration, the three folds produce a total of 4 plies.

As used herein, the phrase “stacked sheets” is used with reference to individual, separate, discrete pieces of air cellular cushioning that can be stacked either in a nesting configuration or in a roll-stacked configuration.

The degree of nesting is determined by comparing a calculated effective height of plies or sheets stacked in a nesting configuration against the calculated effective height of identical sheets in a roll-stacked configuration. If nesting is present, the height of a given number of sheets in nesting configuration will be less than the height the same number of sheets of the same cellular cushioning article in roll-stacked configuration. The percent difference is herein considered to be the “nesting level,” which is generally expressed in terms of “percent nesting.”

Nesting level (and percent nesting) can also be determined between stacks having different numbers of plies or sheets. More particularly, the total height of a stack can be divided by the number of plies or sheets to obtain a “calculated effective individual ply height.” For any given cellular cushioning article, if the calculated effective individual ply height is less for a stack of the plies or sheets in nesting configuration than the calculated effective individual ply height for the stack of sheets in roll-stacked configuration, the percent by which the calculated effective ply height of the plies or sheets in nesting configuration is less that the calculated effective ply height of the sheets in roll stacked configuration is deemed to be the nesting level, which can be expressed in terms of percent nesting.

The term “fan-folded” is used herein with reference to an elongate strand of cellular cushioning having a plurality of transverse folds at regular intervals across the width thereof, with the resulting folded strand being configured so that the strand lengths between folds (herein termed “plies”) are placed in succession on top of one another. Every fan-folded configuration of a cellular cushioning article is also in a nesting configuration because the embossments of the plies of the fan-folded cushioning article are facing one another and in contact with one another.

As used herein, the phrase “packaging article” refers to an article made from a packaging receptacle for a product. After a product is placed into a packaging receptacle, the receptacle is closed to form a packaging article, with the product being contained inside the packaging article. The packaging article is designed to protect and preserve the product for storage and for transport from one location to another while the product remains inside the packaging article. The product is thereafter to be removed from the packaging article for use by a consumer.

Cellular cushioning articles, such as Bubble Wrap® brand cellular cushioning, have an embossed film bonded to a flat backing film. Commercial processes for manufacturing cellular cushioning articles include thermoforming a plurality of discrete embossments on a first film, herein referred to as the embossed film and/or the thermoformed film, with the discrete embossments being separated from one another by a non-embossed land area. After thermoforming is complete, the land area of the embossed film is then bonded to a flat backing film. Air is sealed within the cavities of the embossments, i.e., between the embossed film and the backing film.

In this manufacturing process, the embossed film is heated before being subjected to thermoforming. Moreover, the land area of the embossed film and/or the backing film are hot enough to thermally weld to one another upon contact.

The result of the heating to effect the thermoforming and bonding is that it is hot air that becomes trapped within the chambers formed between the embossed film and the backing film. The air remains hot while the films are hot, but the films immediately begin to cool once the product is completed and is forwarded away from the production equipment and wound up or deposited in a receptacle.

Of course the air sealed within the chambers, which is only under ambient atmospheric pressure, i.e., one atmosphere, then begins the process of cooling to ambient temperature. The cooling of the air inside the cells causes the volume of the cells to reduce in accordance with Boyle's law. As a result, the volume of the gas within each chamber (i.e., each “cell”, also commonly referred to as a “bubble”) is reduced as temperature falls to the ambient temperature level.

The reduction in the volume of the air inside the embossments causes the embossed portions of the film to wrinkle up. As a result, all of the embossed portions of the embossed film of Bubble Wrap® brand cellular cushioning, as well as other brands of such cellular cushioning, do not appear to be “full and tight with air”, but rather appeal “wrinkled.” Of course, this wrinkling of the embossed portions of the embossed film is not a problem, as the cushioning performance of the articles is not hampered by the wrinkles. Rather, the embossed portions of the embossed film stretch tight when in use (i.e., under load), as the wrapping of the cellular cushioning article under tension around a product being packaged, and/or the placing of the cellular cushioning article under a product being packaged, results in placement of a load on the bubbles, causing them to stretch taught as the volume within the bubbles is reduced due to the loading on the bubbles.

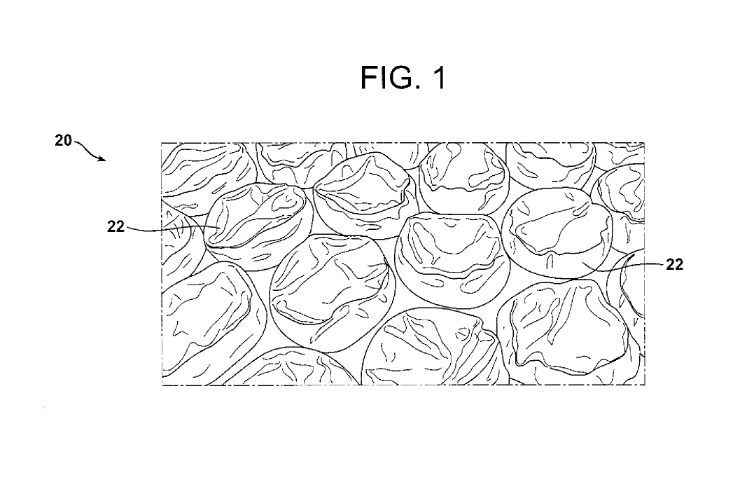

FIG. 1 illustrates a perspective view of the embossments of a typical cellular cushioning article (20) while it is not under load. As is apparent from FIG. 1, both the tops and sides of the embossments 22 have a wrinkled appearance. While the presence of the wrinkles is due to air shrinkage, the particular configuration of each set of wrinkles is a product of the particular manner in which each of the embossments contacted the environment, i.e., contacted machinery, handlers, etc.

The embossments 22 of the cellular cushioning article 20 of FIG. 1 have a circular footprint, i.e., each of the embossments has a circular “base.” The embossed areas can have a base diameter of, for example, ⅜ inch or 1 inch or 1.25 inches, etc. Moreover, in FIG. 1 the embossed areas are arranged so that each embossment 20 is surrounded by six embossments of the same shape and the same size. The embossments are in a regular grid pattern which appears as staggered rows across the width of a strand, i.e., as illustrated in FIG. 9.

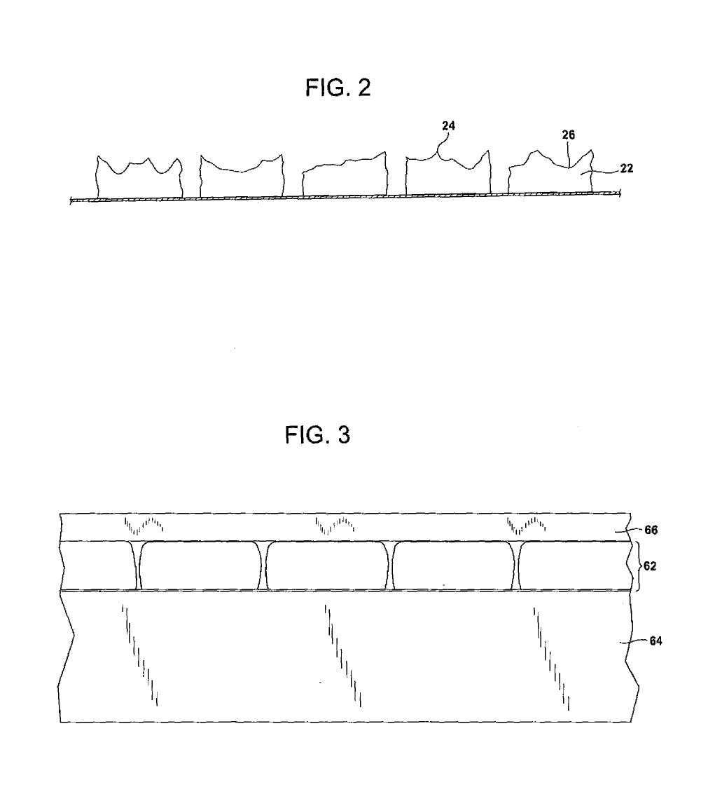

FIG. 2 is a cross-sectional view taken through a single row of embossments such as is illustrated in FIG. 1. Present in various embossments are peaks 24, valleys 26, which form the wrinkles illustrated in FIG. 1.

FIG. 3 is a schematic representation of a portion of a single sheet of cellular cushioning article 62 with the backing film in contact with rigid support member 64 (such as a countertop) and with weight 66 above cushioning article 56. FIG. 3 illustrates an arrangement for accurately and precisely measuring the height of a single sheet of cellular cushioning article 62. Weight 66 contacts the tops of the embossments of cushioning article 62. Weight 66 has a flat surface, and provides a uniform load across cushioning article 62. Weight 66 is selected to provide a relatively light load to cellular cushioning article 62, such as 0.05 pounds per square inch (psi) or 0.08 psi or 0.1 psi, or any other light load designed to simply stretch out the wrinkles in the embossments, position the tops of the embossments to a uniform height above the backing film, and flatten the backing film against horizontal support member 64. In the configuration of FIG. 3, calipers can be used to accurately measure the height of cellular cushioning article 62. In this manner, the height of a single sheet of cellular cushioning can be accurately and precisely measured. Such measurements can be carried out using, for example, a digital caliper or a dial caliper. Applying a known load to a cellular cushioning article and measuring the thickness as a function of time is a test called the “creep test”, and is standardized by ASTM D 2221-01 “Standard Test Method for Creep Properties of Package Cushioning Materials,” hereby incorporated by reference in its entirety.

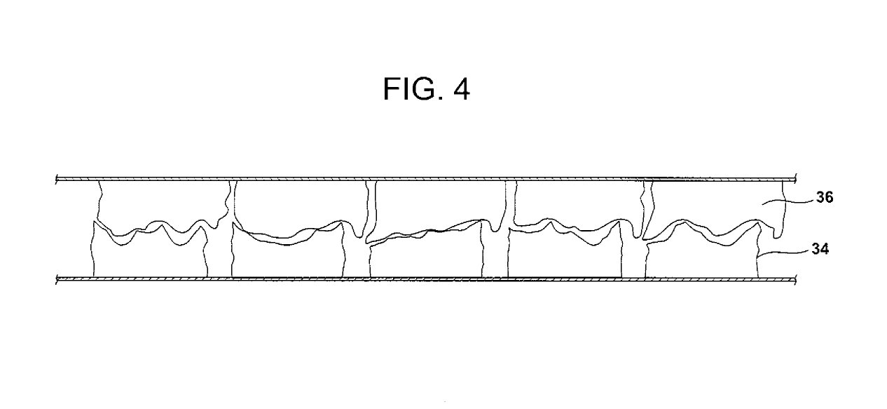

FIG. 4 is a cross-sectional view of two sheets of cellular cushioning article 34, 36 stacked in a nesting configuration, under zero load. As the stiffness of cellular cushioning articles 34 and 36 exceeds the force applied by the weight of cushioning article 36 resting upon cushioning article 34, the wrinkles remain unless a load is applied.

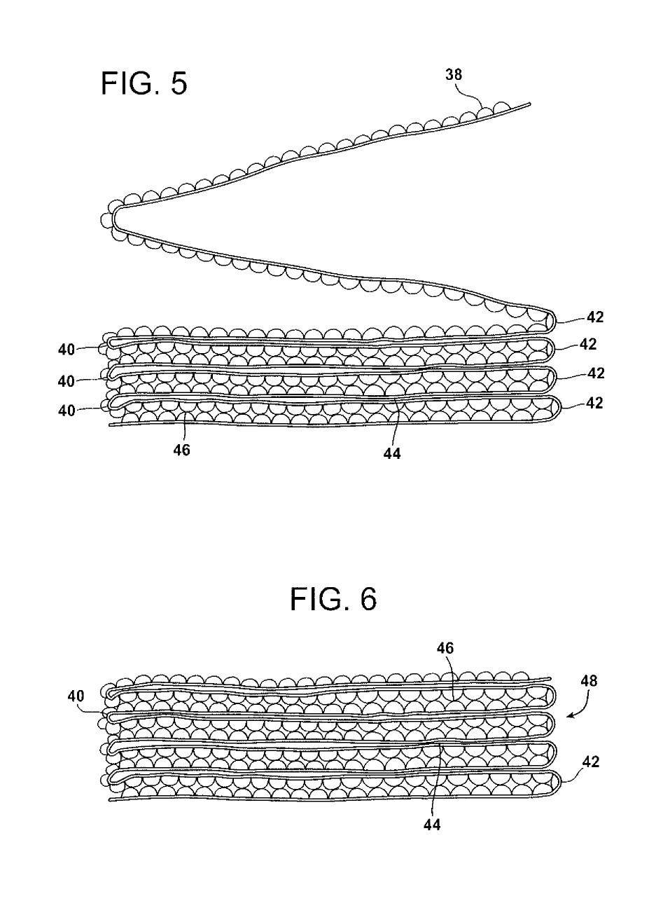

FIG. 5 represents a simplified schematic cross-sectional view of a cellular cushioning article strand in the process of being stacked into a fan-folded configuration. As is apparent in FIG. 5, folds 40 are present down one side of the stack and folds 42 are present down the other side of the stack. Inside the stack, the backing film of one ply contacts the backing film of an adjacent ply at position 44, and the embossment of one ply is in face to face contact with the embossment of an adjacent ply at position 46. FIG. 6 illustrates a fan-folded stack 48 of a cellular cushioning article strand, also showing folds 40, 42, and contact locations 44, 46. In reality, any given cross-sectional view of a stack of cellular cushioning article will likely have more contact locations than shown in FIG. 5 and FIG. 6. However, FIGS. 5 and 6 are simplified schematic views.

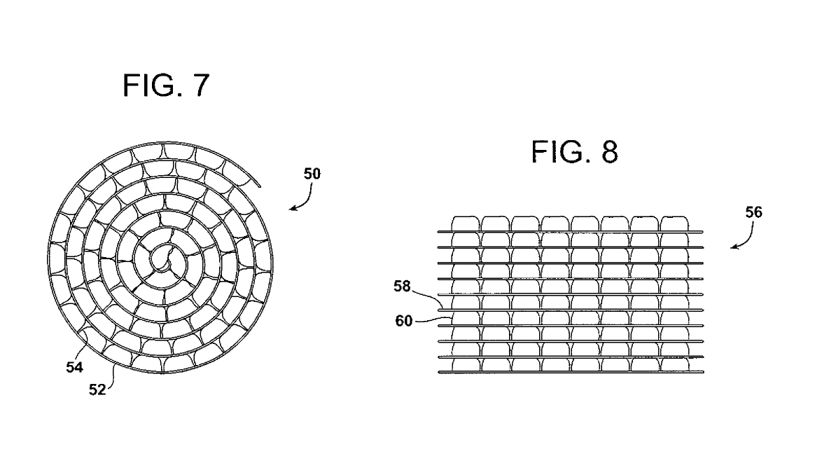

FIG. 7 is a schematic representation of a cellular cushioning article strand in the form of roll 50. Cellular cushioning article has backing film 52 and embossed film 54. As is apparent inside roll 50, the embossments of embossed film 54 face and contact backing film 54. At no point inside roll 50 do embossments of adjacent wraps of embossed film 54 contact each other in a nesting configuration. Although roll 50 is illustrated without a core, alternatively roll 50 could be provided with a core made from a tube of cardboard ⅛ inch thick cardboard, the tube having a 3 inch diameter.

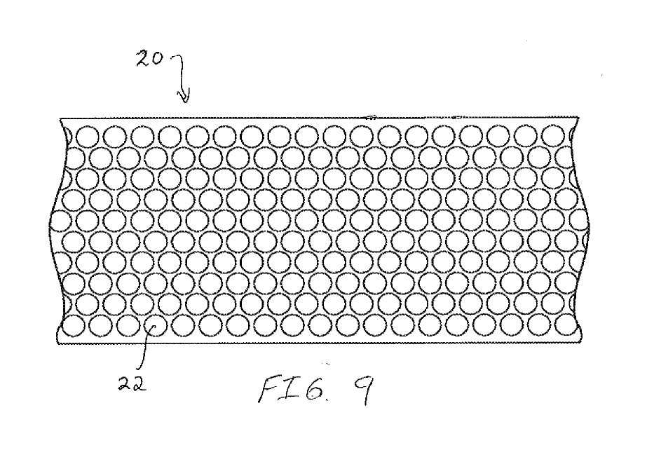

FIG. 8 is a schematic representation of a cross-section of a stack 56 of individual, discrete, separate sheets of a cellular cushioning article, with the sheets placed directly on top of one another in stack 56. Inside stack 56, the tops of the embossments of embossed film 60 contact backing film 58 of an adjacent sheet. At no points inside stack 56 do embossments of adjacent sheets contact each other in a nesting configuration. If a vertical line were to be drawn up through the middle of roll 50 of FIG. 7, it is apparent that the line would pass through, effectively, a “stacked arrangement” of the cellular cushioning article as it passes through the overlapping wraps of roll 50. This arrangement has the characteristics of the stacked arrangement of the sheets of cellular cushioning in FIG. 8, in that at no point inside roll 50 do embossments of adjacent wraps contact one another, with the possible exception of the innermost wrap as illustrated in FIG. 7. As the same sense, the individual sheets of FIG. 8 are stacked in an arrangement similar to the “stacking” of adjacent wraps of roll 50. Hence, the stacking arrangement of the sheets in FIG. 8 is herein referred to as “roll-stacked.”

FIG. 9 is a schematic of a top view of a portion of a strand of cellular cushioning article 20, illustrating the staggered row arrangement of embossments 22. The embossments are arranged in rows directly across the strand, but with every other row staggered to produce a one-surrounded-by-six arrangement of embossments 22. The arrangement of FIG. 9 is a schematic illustration of each of cellular cushioning articles 1 through 5 of the examples below.

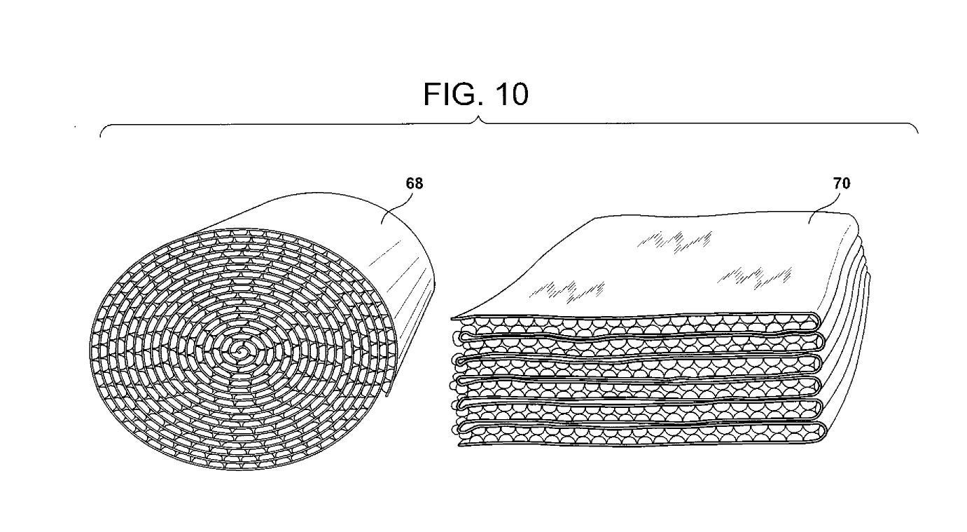

FIG. 10 is a schematic representation of two strands of cellular cushioning articles, with one strand being in a roll configuration and the other strand being in fan-folded configuration. FIG. 10 is a simplified perspective view of a photograph taken of a strand of cellular cushioning article in the form of roll 68 resting on a rigid horizontal support surface, with a single strand of an identical cellular cushioning article configured as fan-folded stack 70. In addition to having been made under the same conditions on the same thermoforming roll, the length of the strand in fan-folded stack 70 was also the same as the length of the strand in roll 68. Although not readily apparent in the schematic of FIG. 10, the roll in the photograph was not placed under any substantial tension when wound up, i.e., was somewhat “loosely wound”, but was not so loose as to have visually apparent separations between adjacent coils of the roll. Although not accurately illustrated in simplified schematic of FIG. 10, measurements taken from the actual photograph showed that the cross-sectional area of the end of the fan-folded stack was 36% less than the cross-sectional area of the end of the roll. As a result, a nesting level of 36 percent was believed to exist in the fan-folded stack. The cellular cushioning article was CC#1 in Table 1, below

Returning to FIG. 1 and FIG. 2, more particularly considering the wrinkled embossments illustrated in FIG. 1 and FIG. 2, a determination of the thickness of the cellular cushioning article, which corresponds with the height of an embossment plus the thickness of the backing film (assuming the backing film is flat, which is not necessarily the case), depends upon the particular position on the embossment being measured. Some areas may have a height 50 percent less, or 100% more, than other areas, depending upon the configuration of the wrinkles at the time. Other criteria for measuring the height of the embossments include: (i) the measurement of the depth of the forming cavity used for thermoforming each of the embossments, or (ii) the actual depth of thermoforming achieved by each of the embossments during the thermoforming operation, as each embossment may or may not bottom out in its respective cavity, depending upon operating conditions, or (iii) the “average” height of any given wrinkled embossment or any given set of wrinkled embossments, or (iv) the height of a wrinkled embossment or set of embossments when placed under a light load, such as 0.05 psi or 0.08 psi or 0.10 psi, i.e., enough load to cause the wrinkles to stretch out smooth without substantial compression of the air within the chamber.

As should be apparent from the embossment height considerations set forth above, different methods of determining the height of the embossments yield different results for the thickness of any given cellular cushioning article. On the one hand, placing the cellular cushioning article under a light load, such as 0.05 psi, 0.08 psi, or 0.10 psi, has long been used as a measurement of the “effective height” of a cellular cushioning article, i.e., the height at which the cellular cushioning article begins to provide cushioning properties. On the other hand, it has long been known that the actual depth of thermoforming achieved in any given process does not necessarily correspond precisely with the depth of the thermoforming cavity. For example, in a production run the actual depth of thermoforming achieved may be about 95% of the depth of the forming cavity. In a different production run making a different embossment, the depth of thermoforming achieved may be only 88% of the depth of the forming cavity.

In summary, without substantially eliminating the wrinkles by placing the cellular cushioning article under a light load during measurement, or without at least placing the article under a load at least temporarily with the load removed and the embossments remaining undisturbed for the height measurement, any assessment of the height of a single sheet of air cellular cushioning has to be qualified with some indication of the manner in which the height is being assessed, as various methods yielding different values are certainly possible. As is apparent from FIG. 1 and FIG. 2, the height of any given embossment depends upon the particular region of the embossment being measured. Even if the assessment method is specified, the indication of height of the cellular cushioning would have little meaning, as the effective height of the cellular cushioning article requires that the article be under a load light enough to stretch out the wrinkles and allow the air within the chamber to assume a pressure at least minutely above atmospheric pressure.

### EXAMPLES

Although most of the examples below were carried out using “CC#1” (i.e., cellular cushioning article no. 1) and “CC#2” (i.e., cellular cushioning article no. 2), each of which had the characteristics set forth in Table 1 below. However, similar results could be obtained using CC#3, CC#4, CC#5, and many other cellular cushioning articles having an embossed area of at least 60% and a land area of up to 40%.

Each of cellular cushioning articles 1 through 5 were made from two thermoplastic films heat laminated to one another throughout the land areas between embossments. In all of the examples, all embossments had round bases. All of the cushioning articles in Table 1 had the embossments configured in a “one-surrounded-by-six” arrangement (FIG. 1 illustrates a one-surrounded-by-six arrangement). More particularly, in a one-surrounded-by-six arrangement, any selected embossment is surrounded by a set of six embossments each of which is spaced the same distance from the selected embossment. For each of CC#1 through CC#5, Table 1 provides information pertaining to the shape and depth of the forming cavity, the diameter of the “base” portion of the forming cavity which determines the diameter of the base of the resulting embossment, the cell height measured at 140° F. (because without placing load on the cell, the height cannot be measured at room temperature because the bubble is wrinkled), the distance between the center points of adjacent embossments, the minimum distance between embossments (i.e., the minimum distance between the edge of a selected embossment and the edges of the six embossments surrounding the selected embossment.

TABLE 1

| | | | | | Cell | | | | |
|---|---|---|---|---|---|---|---|---|---|
| | | | Cavity | | height | Distance | Min. | | |
| | Forming | Forming | base | | (air | between | Distance | Emboss. | Land |
| | Cavity | Cavity | dia. | Radius | temp | centers | between | Area | Area |
| CC # | Shape | Depth | (in.) | (in.) | 140° F.) | (in.) | emboss. | (%) | (%) |
| 1 | SSH* | 0.210 | 0.375 | 0.185 | 0.201 | 0.453 | 0.078 | 76.7 | 23.3 |
| 2 | CWw/R&FB* | 0.672 | 1.250 | 0.31 | 0.592 | 1.350 | 0.100 | 64.4 | 35.6 |
| 3 | CWw/R&FB | 0.440 | 1.000 | 0.25 | 0.422 | 1.100 | 0.100 | 78.5 | 21.5 |
| 4 | CWw/R&FB | 0.140 | 0.375 | 0.062 | 0.131 | 0.440 | 0.065 | 80.0 | 20.0 |
| 5 | CWw/R&FB | 0.165 | 0.375 | 0.185 | 0.154 | 0.453 | 0.078 | 76.7 | 23.3 |

*SSH = substantially semi-hemispherical
**CWw/R&FB = cylindrical wall followed by radius leading to flat bottom
n/a = not measured

### Examples 1-9

Examples 1-9 in Table 2, below, provide data for various configurations of CC#1 of Table 1, above. Each of the various configurations was prepared using a strand of CC#1 having a width of 12 inches.

In Examples 1 and 2, the strand of CC#1 was fan-folded at 12 inch intervals, with the first 12 inch segment of the strand of CC#1 (herein referred to as a “ply”) placed on a horizontal countertop with the backing film in contact with the countertop. As the folding of the strand of CC#1 was carried out, each successive ply was placed on top of the preceding ply, to configure the strand into the fan-folded stack of plies as illustrated in FIG. 5.

In Example 1, 40 plies of CC#1 were fan-folded into a stack. Although no weight was placed on top of the fan-folded stack, the stack was momentarily placed under light manual pressure to eliminate the voids. Of course, the light manual pressure was removed before a height measurement was taken. The height of the 40 fan-folded plies was measured at 5 inches, yielding a calculated effective height per ply of 0.125 inches. Measurement of the height of the fan-folded stack was conducted by using a tape measure measuring from base of stack up to top of stack, assessed by eye.

In Example 2, 40 plies of CC#1 were fan-folded into a stack. The stack was placed under a load of 0.08 psi using a cast iron metal plate having dimensions of 6 inches wide, 6 inches long, and one inch thick, weighing 10.2 pounds, which was placed on top of a sheet of corrugate having dimensions of 9 inches wide and 11 inches long. The resulting plate and corrugate placed a load of 0.103 psi on the fan-folded stack. The height of the 40 fan-folded plies was measured at 4.5 inches while remaining under the 0.103 psi load, yielding a calculated effective height per ply of 0.112 inches. Measurement of the height of the fan-folded stack was conducted in the same manner described in Example 1, i.e., using a tape measure extended from the countertop to the top of the stack, with the measurement sighted by eye.

In Examples 3 and 4, a 12 inch wide, 30 foot long strand of CC#1 was cut apart transversely to make 30 individual pieces each 12 inches wide and 12 inches long. A first piece was placed on a horizontal countertop with the backing film in contact with the countertop and the embossments oriented up. A second piece was placed on top of the first piece, but with embossments oriented down. A third piece was placed on top of the second piece, but with embossments oriented up. This “up-down” stacking was continued until all 30 pieces were stacked into a stack 30 pieces (i.e., plies) high. The vertical stacking of individual pieces of a cellular cushioning article with embossments oriented in alternating up-down-up-down fashion produces a stacking configuration in which backing sheets of adjacent plies contact one another and embossments of adjacent plies contact each other with the opportunity to nest into one another, just as in a fan-folded stack. However, the effects of folding of the strand are not present because the strand has been cut into as many pieces are there are plies in the stack. As a result, the arrangement of Examples 3 and 4 is herein termed “a stack of sheets in a nesting configuration.”

In Example 3, 30 individual sheets (i.e., plies) of CC#1 were stacked in a nesting configuration. No weight was placed on top of the stack of individual sheets in nesting configuration. Although no weight was placed on top of the stack of sheets in nesting configuration, the stack was momentarily placed under light manual pressure to eliminate the voids. Of course, the light manual pressure was removed before a height measurement was taken. The height of the 30 stacked individual sheets in nesting configuration was measured at 3.75 inches, yielding a calculated effective height per ply of 0.125 inches. Again, measurement of the height of the stack of individual sheets in nesting configuration was conducted as described in Example 1, above.

In Example 4, 30 sheets (i.e., plies) of CC#1 were stacked in a nesting configuration. The stack was weighted to a load level of 0.103 psi in the same manner described in Example 2, above. The height of the 30 stacked sheets in nesting configuration was measured at 3.125 inches, yielding a calculated effective height per ply of 0.104 inches. Again, measurement of the height of the stacked sheets in nesting configuration was conducted as described in Example 1, above.

In Examples 5 and 6, a 12 inch wide 30 foot long strand of CC#1 was cut apart transversely to make 30 individual pieces each 12 inches wide and 12 inches long. A first piece was placed on a horizontal countertop with the embossments oriented downward, i.e., embossments in contact with the countertop, with the backing film oriented upward, off of the countertop. A second piece was placed on top of the first piece, also with the embossments oriented downward, contacting the backing film from the first piece. This stacking of the pieces with the embossments down, backing film up, was continued for all 30 pieces, to make a 30-ply stack. This backing-film-to-embossed-film arrangement places the plies in the same position relative to one another as is present in a roll of a continuous strand of cellular cushioning having the backing film exposed on the outside of the roll. In such a roll, with the exception of the last wrap, in each wrap the backing film contacts the embossed film of the preceding wrap. As a result, the arrangement of the stacked sheets of Examples 5 and 6 is herein termed “sheets in roll-stacked configuration.”

In Example 5, 30 sheets (i.e., plies) of CC#1 were stacked in roll-stacked configuration. No weight was placed on top of the stack in the roll-stacked configuration. Although no weight was placed on top of the stack of sheets in roll-stacked, the stack was momentarily placed under light manual pressure to eliminate the voids. Of course, the light manual pressure was removed before a height measurement was taken. The height of the 30 stacked sheets in roll-stacked configuration was measured at 4.75 inches, yielding a calculated effective height per ply of 0.158 inches. Measurement of the height of the fan-folded stack was conducted as described in Example 1, above.

In Example 6, 30 sheets (i.e., plies) of CC#1 were stacked in roll-stacked configuration. The stack was weighted to a load level of 0.103 psi as described in Example 2, above. The height of the 30 stacked sheets in roll-stacked configuration was measured at 3.875 inches, yielding a calculated effective height per ply of 0.129 inches. Measurement of the height of the fan-folded stack was conducted as described in Example 1, above.

In Examples 7 and 8, 30-foot long, 12-inch wide strands of CC#1 were manually wound into a roll. In Example 7, the roll was wound without applying tension, resulting in a roll having a total of 25 wraps. Viewing the roll from the end (a shorter roll is illustrated in FIG. 10) and counting plies from the bottom to the top, it was apparent that the roll of 25 wraps had, effectively, a total of 50 “plies” roll-stacked on top of one another, in that from the bottom of the roll to the center 25 plies were counted, and from the middle of the roll to the top an additional 25 plies were counted. The height of the 25 wrap (50 ply) “untensioned” roll was measured at 8 inches, yielding a calculated effective height per ply of 0.160 inches. Measurement of the height of the untensioned roll was conducted using a tape measure extended from the base of the roll to the top of the roll, as assessed by eye.

In Example 8, the roll was wound applying tension, resulting in a roll having a total of 30 wraps. As with the roll of Example 7, counting plies from the bottom of the roll to the top of the roll, it was apparent that the roll a total of 60 “plies” roll-stacked on top of one another. The height of the 30 wrap (60 plies) tensioned roll was measured at 7.25 inches, yielding a calculated effective height per ply of 0.120 inches. Measurement of the height of the tensioned roll was conducted using a tape measure extended from the base of the roll to the top of the roll, as assessed by eye.

TABLE 2

| | | | Applied | | | Calculated Effective |
|---|---|---|---|---|---|---|
| Ex. | | | Load | Number | Height | Individual Ply Height |
| No. | CC# | Configuration | (psi) | of Plies | (inches) | (inch) |
| 1 | 1 | Fan-Folded Stack | 0* | 40 | 5 | .125 |
| | | (one strand) | | | | |
| 2 | 1 | Fan-Folded Stack | 0.103 | 40 | 4.5 | .112 |
| | | (one strand) | | | | |
| 3 | 1 | Stacked Sheets | 0* | 30 | 3.75 | .125 |
| | | Nesting | | | | |
| | | Configuration | | | | |
| 4 | 1 | Stacked Sheets | 0.103 | 30 | 3.125 | .104 |
| | | Nesting | | | | |
| | | Configuration | | | | |
| 5 | 1 | Stacked Sheets: | 0* | 30 | 4.75 | .158 |
| | | Roll-Stacked | | | | |
| | | Configuration | | | | |
| 6 | 1 | Stacked Sheets: | 0.103 | 30 | 3.875 | .129 |
| | | Roll-Stacked | | | | |
| | | Configuration | | | | |
| 7 | 1 | Roll (untensioned) | 0 | 50 | 8 | .16 |
| 8 | 1 | Roll (tensioned) | 0 | 60 | 7.25 | .120 |

0*: stack momentarily subjected to light manual pressure to eliminate separations between plies; pressure removed, and stack allowed to recover height less separations, before height measurement taken.

A comparison of Example 1 with Example 3 indicates that under no load, the fan-folded CC#1 exhibited the same effective height per ply in the fan-folded configuration as in the stacked sheet nested configuration.

A comparison of Examples 2 and 4 indicated that under a light load (0.103 psi), fan-folded CC#1 exhibited a greater effective height per ply in the fan-folded configuration than in the stacked sheet nested configuration (0.112 inch vs. 0.104 inch). The 7% reduction in effective ply height between Examples 2 and 4 supports the conclusion that a fan-folded stack is more resistant to nesting than an otherwise identical set of individual sheets stacked in a nested configuration.

A comparison of Examples 1 and 3 with Example 5 reveals that under no load, the fan-folded stack of Example 1 and the stacked sheets in nested configuration of Example 3 exhibited a 26% nesting level, i.e., a 26% lower effective height per ply (0.125 inch vs. 0.158 inch), indicating that a stack of 30-40 plies of CC#1 exhibits substantial nesting in both fan-folded configuration and stacked sheets in nested configuration, relative to stacked sheets in roll-stacked configuration in which embossment-to-embossment nesting is not possible.

A comparison of Examples 2 and 4 with Example 6 indicates that under a light load (0.103 psi), the fan-folded strand of CC#1 (Example 2), as well as the stacked sheets of CC#1 in nesting configuration (Example 4) exhibited lower calculated individual effective ply height than the calculated individual ply height in the set of stacked sheets in roll-stacked configuration (Example 6). The resulting approximately 13% nesting level, i.e., 13% lower calculated individual effective ply height (Example 2 vs. Example 6) and the approximately 19% nesting level, i.e., approximately 19% lower effective individual ply height (Example 4 vs. Example 6) indicate substantial nesting under 0.08 psi load.

A comparison of Example 8 against Example 7 reveals that application of tension to the strand being wound up can significantly reduce the effective height of the roll (from 8 inches to 7.25 inches), but the reduction in diameter cannot be due to embossment-to-embossment nesting, as all embossments face backing sheets in every roll. It appeared that the tension applied to the strand caused the air in the cells to compress, resulting in a lower volume and hence a smaller diameter. That reduction in the effective height per ply of the tensioned roll versus the untensioned roll is believed to occur for the same reason.

### Examples 9 through 12

Examples 9-12 in Table 3, below, provide additional data for various configurations of CC#1 of Table 1, above. The variations of Examples 9, 10, and 11 were prepared sequentially, beginning with a single strand of CC#1. The variation in Example 12 was prepared using a separate strand of CC#1. In each of Examples 9-12, the strand of CC#1 had a width of 12 inches and a length of 30 feet.

In Example 9, the single 12-inch wide, 30-foot long strand of CC#1 was fan-folded on a rigid countertop. Folds were made across the strand every 12 inches. A total of 30 plies were present in the resulting fan-folded stack. Although the resulting stack was momentarily lightly “tamped” with the palm of a hand to remove voids between plies, afterwards no weight was placed on top of the fan-folded stack. The height of the resulting tamped no-load stack of 30 fan-folded plies of CC#1 was measured at 3.5 inches, yielding a calculated effective height per ply of 0.117 inches. Measurement of the height of the fan-folded stack was conducted by placing a light plastic ruler across the top of the stack and measuring the distance of each end of the ruler from the countertop. The placement of the ruler across the fan-folded stack did not cause the stack to compress substantially. The measured height was the average of the height of the two ends of the ruler from the countertop.

In Example 10, each of the 29 folds in the fan-folded stack from Example 9 was cut with a pair of scissors without unfolding the fan-folded stack. Then the stack was manually “fluffed up” followed by a light manual tamping with the palm of a hand to remove separations between plies, and the stack height of the resulting set of 30 sheets stacked in nesting configuration was measured at 3.75 inches, yielding a calculated effective height per ply of 0.125 inches. Measurement of the height of the 30 sheets stacked in nesting configuration was conducted in the same manner as the height was measured in Example 9.

In Example 11, the stack of 30 sheets from Example 10 was dismantled in that the plies oriented with downward-facing embossments were reversed and returned to the stack to produce a stack of 30 roll-stacked sheets (see the roll-stack description of Examples 5 and 6, above, as well as FIG. 7). The stack of 30 roll-stacked sheets was then manually “fluffed up” followed by a light manual tamping with the palm of a hand to remove separations between plies, and the stack height of the resulting set of 30 roll-stacked sheets was measured at 4.35 inches, yielding a calculated effective height per ply of 0.145 inches. Measurement of the height of the stack of 30 roll-stacked sheets was conducted in the same manner as the height was measured in Example 10.

In Example 12, a single 12-inch wide, 30-foot long strand of CC#1 was manually rolled up into a roll without applying tension to the strand during roll up. The roll was made beginning around the first approximately 4 to 6 inches of the strand which remained in a flat configuration during the roll up. The resulting untensioned roll, which had a total of 30 roll-stacked plies, was tamped to remove voids between plies. The height of the resulting tamped untensioned roll having an effective 30 plies of CC#1 was measured at 3.9 inches, yielding a calculated effective height per ply of 0.130 inches. Measurement of the height of the roll was conducted in the same general manner as the height of the fan-folded stack of Example 9.

TABLE 3

| | | | | | Calculated | Relative |
|---|---|---|---|---|---|---|
| | | | | | Effective | Thickness |
| | | | | | Individual | (%) |
| | | | No. | Stack | Height | (compared |
| Ex. | | | of | Thickness | Per Ply | with fan- |
| No. | CC# | Configuration | Plies | (inches) | (inch) | folding) |
| 9 | 1 | fan-folded | 30 | 3.5 | 0.117 | — |
| 10 | 1 | sheets stacked | 30 | 3.75 | 0.125 | 107 |
| | | in nesting | | | | |
| | | configuration | | | | |
| 11 | 1 | sheets in roll | 30 | 4.35 | 0.145 | 124 |
| | | stacked | | | | |
| | | configuration | | | | |
| 12 | 1 | untensioned | 30 | 3.9 | 0.130 | 111 |
| | | roll | | | | |

The results in Table 3 include the calculated effective ply height difference of Examples 9 and 10, each of which is in a configuration for facing embossments to nest into one another, versus the effective ply height in Examples 11 and 12, which are not in a configuration for facing embossments to nest into one another. The stacked sheets in roll-stacked configuration (Example 11) had a 24% greater calculated effective individual ply height (0.145 inch) than the calculated effective individual ply height (0.117 inch) of the fan-folded configuration (Example 9). As both samples were under no load, this data supports the conclusion of substantial nesting (i.e., 0.117/0.145×100=nesting level of about 20%) present in the fan-folded embodiment under loading of 0.08 psi.

### Examples 13-23

Examples 13-23 in Table 4, below, provide further data for various configurations of CC#1 of Table 1, above. Each of the various configurations was prepared using a strand of CC#1 having a width of 12 inches.

In Examples 13-15, a 20 foot long strand of CC#1 was fan-folded at 12 inch intervals, resulting in 20 plies of CC#1 fan-folded into a stack. In Example 13, the fan-folded stack of 20 plies was not under load during the height measurement. However, a wooden box having a base 12 inches wide and 12 inches long, the box containing lead shot and weighing 7.1 pounds, was placed on top of the fan-folded stack of plies for 20 seconds, thereby placing the stack under a load of 0.05 psi. This temporary loading was applied in order to remove existing separations between plies. After removal of the box, the stack was given time to rise to an equilibrium height before the height measurement was taken. The height of the unloaded stack was measured by placing a small diameter copper wire on the top of the stack, with an electronic caliper being used to measure the distance from the surface of the countertop (on which the fan-folded stack was resting) to the wire. The load placed on the stack by the wire was low enough that the loading made no readily visible reduction in the height of the stack.

In Example 14, the height of the fan-folded stack of 20 plies from Example 13 was measured while under load of 0.05 psi. Load was applied using the shot-containing wooden box described in Example 13, thereby placing the plies under a load of 0.05 psi. The height of the stack measured under the 0.05 psi load in Table 4 for Example 14.

In Example 15, the stack from Example 14 had the weight removed and a heavier weight was placed in the wooden box having the 12×12 inch base, to bring the weighted box to a total weight of 14.2 pounds. This heavier weight placed the fan-folded stack of Example 13 under a load of 0.10 psi. The height of the stack measured under the 0.10 psi load is reported in Table 4 in Example 15.

In Examples 16-18, a 30 foot long, 12 inch wide strand of CC#1 was cut into 20 pieces, each of which had a length of 12 inches and a width of 12 inches. The pieces were manually stacked up in a nesting configuration (see Examples 3 and 4, above). In Example 16 the height of the stack was measured with a caliper, with the height measurement made after the 0.05 psi load was removed from the stack and the stack given time to return to an unloaded height, after which the measurement was taken, using the copper wire as described above in Example 13.

In Example 17, the height of the 30 individual sheets in nesting configuration from Example 16 was measured while under load of 0.05 psi. Load was applied using the 7.1 pound shot-containing wooden box described in Example 13, thereby placing the 30 individual plies in nesting configuration under the 0.05 psi load. The height of the 30 individual sheets in nesting configuration was measured while under the 0.05 psi load in the manner described in Example 14, above. The measured height of the 30 individual sheets stacked in nesting configuration under the 0.05 psi load is reported in Table 4 for Example 17.

In Example 18, the height of the 30 individual sheets stacked in nesting configuration from Example was measured while under a load of 0.10 psi. Load was applied using the 14.2 pound shot-containing wood box described in Example 14, thereby placing the plies under the 0.10 psi load. The height of the stack was measured under the 0.10 psi load in the same manner as described above in Example 14. The measured height of the 30 individual sheets stacked in nesting configuration stack is reported in Table 4 for Example 18.

In Examples 19-21, a 30 foot long, 12 inch wide strand of CC#1 was cut into 30 pieces, each of which had a length of 12 inches and a width of 12 inches. The pieces were manually stacked up in a roll-stacked configuration (see Examples 5 and 6, above). In Example 19 the height of the stack was measured with a caliper, with the height measurement made after the 0.05 psi load was removed from the stack and the stack given time to return to an unloaded height, after which the measurement was taken, using the caliper and copper wire as described above in Example 13. The measured height of the stack is reported in Table 4 for Example 19.

In Example 20, the height of the 30 individual sheets in roll-stacked configuration from Example 19 was measured while under the load of 0.05 psi. Load was applied using the 7.1 pound shot-containing wooden box described in Example 13, thereby placing the plies under the 0.05 psi load. The height of the stack was measured under the 0.05 psi load in the same manner as described above in Example 14. The measured height of the 30 individual sheets in roll-stacked configuration under the 0.05 psi load is reported in Table 4 for Example 20.

In Example 21, the height of the 30 individual sheets in roll-stacked configuration from Example 20 was measured while under a load of 0.10 psi. Load was applied using the 14.2 pound shot-containing wood box described in Example 14, thereby placing the plies under the 0.10 psi load. The height of the stack was measured under the 0.10 psi load in the same manner as described above in Example 14. The measured height of the 30 individual sheets in roll-stacked configuration under the 0.10 psi load is reported in Table 4 for Example 21.

In Examples 22, a 12 inch long, 12 inch wide individual sheet of CC#1 was placed on a counter top by itself, with embossments oriented downward against the counter top, and a load of 0.05 psi was applied using the 7.1 pound shot-containing wooden box described in Example 13, thereby placing the single sheet of CC#1 under the 0.05 psi load. The height of the single sheet was measured under the 0.05 psi load in the same manner as described above in Example 14. The measured height of the single sheet under the 0.05 psi load is reported in Table 4 for Example 22.

In Examples 23, the 12 inch long, 12 inch wide individual sheet of CC#11 from Example 22 placed on a counter top by itself, with embossments oriented downward against the counter top, and a load of 0.10 psi was applied using the 714.2 pound shot-containing wooden box described in Example 13, thereby placing the single sheet of CC#1 under the 0.10 psi load. The height of the single sheet was measured under the 0.10 psi load in the same manner as described above in Example 14. The measured height of the single sheet under the 0.10 psi load is reported in Table 4 for Example 23.

TABLE 4

| | | | | | | Calculated |
|---|---|---|---|---|---|---|
| | | | | | | Effective |
| | | | Applied | Number | | Individual |
| Ex. | | | Load | of | Height | Ply Height |
| No. | CC# | Configuration | (psi) | Plies | (inches) | (inches) |
| 13 | 1 | Fan Folded | 0* | 20 | 3.006 | 0.150 |
| | | Stack | | | | |
| 14 | 1 | Fan Folded | 0.05 psi | 20 | 2.556 | 0.128 |
| | | Stack | | | | |
| 15 | 1 | Fan Folded | 0.1 psi | 20 | 2.316 | 0.116 |
| | | Stack | | | | |
| 16 | 1 | Stacked | 0* | 30 | 4.416 | 0.147 |
| | | Sheets | | | | |
| | | Nesting | | | | |
| | | Configuration | | | | |
| 17 | 1 | Stacked | 0.05 psi | 30 | 3.564 | 0.119 |
| | | Sheets | | | | |
| | | Nesting | | | | |
| | | Configuration | | | | |
| 18 | 1 | Stacked | 0.1 psi | 30 | 3.390 | 0.113 |
| | | Sheets | | | | |
| | | Nesting | | | | |
| | | Configuration | | | | |
| 19 | 1 | Stacked | 0* | 30 | 4.527 | 0.151 |
| | | Sheets | | | | |
| | | Roll-Stacked | | | | |
| | | Configuration | | | | |
| 20 | 1 | Stacked | 0.05 psi | 30 | 4.001 | 0.133 |
| | | Sheets | | | | |
| | | Roll-Stacked | | | | |
| | | Configuration | | | | |
| 21 | 1 | Stacked | 0.1 psi | 30 | 3.885 | 0.130 |
| | | Sheets | | | | |
| | | Roll-Stacked | | | | |
| | | Configuration | | | | |
| 22 | 1 | Single Ply | 0.05 psi | 1 | 0.149 | 0.149 |
| | | (i.e., single | | | | |
| | | sheet of | | | | |
| | | CC#1) | | | | |
| 23 | 1 | Single Ply | 0.1 psi | 1 | 0.144 | 0.144 |
| | | (i.e., single | | | | |
| | | sheet of | | | | |
| | | CC#1) | | | | |

0* = no weight present during measurement of height, but plies subjected to 0.05 psi for 20 seconds to substantially remove voids between plies, with stack height measurement taken only after stack allowed to rise to equilibrium height after load removed

The results in Table 4 support the conclusion that the ply-height relationships were found to be, for any given load level: “single ply” always had a higher individual ply height than the calculated effective individual ply height of a “stack of 30 roll-stacked sheets,” which in turn always had a higher calculated effective individual ply height than the calculated effective individual ply height of a “fan-folded stack of 20 plies made from single strand”, which in turn always had a higher calculated effective individual ply height than the calculated effective individual ply height of a “set of 30 separate plies in a roll-stacked configuration.” This relationship was found to be true for the following load levels: (i) 0.05 psi load temporarily applied to remove voids, with load removed and stack allowed to rise to substantial equilibrium before height measurement taken, (ii) height measurement under load of 0.05 psi; and (iii) height measurement under load of 0.1 psi. These results show measurable amounts of nesting of embossments for all examples measured under 0.05 psi and 0.10 psi load levels in which the embossments were in face-to-face contact with one another, by comparison with both (i) the examples stacked in a non-nesting configuration (i.e., the roll stacked sheets and the individual plies measured.

### Examples 24 through 42

Examples 24-42 in Table 5, below, provide further data for various configurations of CC#1 and CC#2 of Table 1, above. Each of the various configurations was prepared using a strand having a width of 12 inches.

In each of Examples 24-42, each example listed as having an applied load of “0” was subjected to a temporary load of 0.05 psi as described in Example 13, above, with the height being measured as also described in Example 13, above. In each of Examples 24-42, each example listed as having an applied load of “0.05 psi” was subjected to loading of 0.05 psi in the manner described in Example 14, above, with the height being measured as also described in Example 14, above. In each of Examples 24-42, each example listed as having an applied load of “0.10 psi” was subjected to loading of 0.10 psi in the manner described in Example 15, above, with the height being measured as also described in Example 15, above. In each of Examples 24-42, the phrases “stacked sheets in nesting configuration”, “stacked sheets in roll-stacked configuration” have the plies arranged as described in corresponding examples above.

TABLE 5

| | | | | | | Calculated |
|---|---|---|---|---|---|---|
| | | | | | | Effective |
| | | | Applied | | Measured | Height |
| | | | Load | No. | Height | per Ply |
| Ex. # | CC# | Configuration | (psi) | Plies | (inches) | (inch) |
| 24 | 1 | Stacked | 0.05 | 2 | 0.239 | 0.120 |
| | | Sheets Nesting | | | | |
| | | Configuration | | | | |
| 25 | 1 | Stacked Sheets | 0* | 2 | 0.295 | 0.148 |
| | | in Nesting | | | | |
| | | Configuration | | | | |
| 26 | 1 | Stacked Sheets | 0.05 | 10 | 1.197 | 0.120 |
| | | in Nesting | | | | |
| | | Configuration | | | | |
| 27 | 1 | Stacked Sheets | 0* | 10 | 1.440 | 0.144 |
| | | in Nesting | | | | |
| | | Configuration | | | | |
| 28 | 1 | Stacked Sheets | 0.05 | 20 | 2.394 | 0.120 |
| | | in Nesting | | | | |
| | | Configuration | | | | |
| 29 | 1 | Stacked Sheets | 0* | 20 | 2.921 | 0.146 |
| | | in Nesting | | | | |
| | | Configuration | | | | |
| 30 | 1 | Single Sheet, | 0.05 | 1 | 0.149 | 0.149 |
| | | embossments | | | | |
| | | face down | | | | |
| 31 | 1 | Single Sheet, | 0* | 1 | 0.151 | 0.151 |
| | | embossments | | | | |
| | | face down | | | | |
| 32 | 1 | Stacked Sheets | 0.05 | 10 | 1.365 | 0.137 |
| | | in Roll-Stacked | | | | |
| | | Configuration | | | | |
| 33 | 1 | Stacked Sheets | 0* | 10 | 1.575 | 0.158 |
| | | in Roll-Stacked | | | | |
| | | Configuration | | | | |
| 34 | 1 | Stacked Sheets | 0.05 | 20 | 2.716 | 0.136 |
| | | in Roll-Stacked | | | | |
| | | Configuration | | | | |
| 35 | 1 | Stacked Sheets | 0* | 20 | 3.078 | 0.154 |
| | | in Roll-Stacked | | | | |
| | | Configuration | | | | |
| 36 | 2 | Stacked Sheets | 0.05 | 2 | 0.908 | 0.454 |
| | | in Nesting | | | | |
| | | Configuration | | | | |
| 37 | 2 | Stacked Sheets | 0* | 2 | 1.005 | 0.503 |
| | | in Nesting | | | | |
| | | Configuration | | | | |
| 38 | 2 | Stacked Sheets | 0.05 | 10 | 4.582 | 0.458 |
| | | in Nesting | | | | |
| | | Configuration | | | | |
| 39 | 2 | Stacked Sheets | 0* | 10 | 5.042 | 0.504 |
| | | in Nesting | | | | |
| | | Configuration | | | | |
| 40 | 2 | Single Sheet, | 0.05 | 1 | 0.484 | 0.484 |
| | | embossments | | | | |
| | | face down | | | | |
| 41 | 2 | Single Sheet, | 0* | 1 | 0.528 | 0.528 |
| | | embossments | | | | |
| | | face down | | | | |
| 42 | 2 | Stacked Sheets | 0.05 | 10 | 4.858 | 0.486 |
| | | in Roll-Stacked | | | | |
| | | Configuration | | | | |
| 43 | 2 | Stacked Sheets | 0* | 10 | 5.130 | 0.513 |
| | | in Roll-Stacked | | | | |
| | | Configuration | | | | |

0* = no weight present during measurement of height, but plies subjected to 0.05 psi for 20 seconds to substantially remove voids between plies, with stack height measurement taken only after stack allowed to rise to equilibrium height after load removed

The data in Examples 24-35 supports various conclusions for the nesting of CC#1. A comparison of Example 31 with Example 25 demonstrates that under zero load at measurement (but with a temporary loading which was removed before measurement) the single ply of Example 31 exhibited a height of 0.151 inches, which when doubled (0.302 inch) is greater than the measured height (0.295 inch) of two individual plies stacked in nesting relationship of Example 25. The difference indicates a nesting level at zero load of about 2.3 percent.

A comparison of Example 30 with Example 24 demonstrated that under a loading of 0.05 psi at measurement, the single ply of Example 30 exhibited a height of 0.149 inch, which when doubled (0.298 inch) is greater than the measured height (0.239 inch) under 0.05 psi of two individual plies stacked in nesting relationship of Example 24. This difference indicates a nesting level of about 20% for the two plies in nesting configuration under 0.05 psi load (Example 24).

A comparison of Example 27 with Example 33 demonstrated that under zero load at measurement (but with a temporary loading which was removed before measurement) the stack of 10 sheets in nested configuration of Example 27 had a calculated effective height per ply of 0.144 inch, whereas the roll-stacked sheets of Example 33 had a calculated effective height per ply of 0.158 inch, supporting the conclusion that the plies of Example 27 exhibited a nesting level of about 9 percent.

A comparison of Example 26 with Example 32 demonstrated that under a load level of 0.05 psi at measurement, the 10 sheets in stacked nested configuration exhibited a calculated effective height per ply of 0.120 inch, whereas the 10 roll-stacked sheets of Example 32 had a calculated effective height per ply of 0.137 inch, supporting the conclusion that the plies of Example 26 exhibited a nesting level of over 12 percent.

A comparison of Example 29 with Example 35 demonstrated that under a 0 load level at measurement (but with a temporary loading which was removed before measurement) the 20 stacked sheets in nesting configuration of Example 29 exhibited a calculated effective height per ply of 0.146 inch, whereas the 10 roll-stacked sheets of Example 35 had a calculated effective height per ply of 0.154 inch, supporting the conclusion that the plies of Example 26 exhibited a nesting level of about 5 percent.

A comparison of Example 28 with Example 34 demonstrated that under a load level of 0.05 psi at measurement, the 20 sheets in stacked nested configuration exhibited a calculated effective height per ply of 0.120 inch, whereas the 10 roll-stacked sheets of Example 34 had a calculated effective height per ply of 0.136 inch, supporting the conclusion that the plies of Example 26 exhibited a nesting level of about 12 percent.

A comparison of Examples 25, 27 and 29 reveals the consistency of the measurement technique for assessment of the calculated effective height per ply under zero load for stacks of 2, 10, and 20 plies in nesting configuration after application of a temporary load that was removed before measurement. Those measurements were 0.148 inch, 0.144 inch, and 0.146 inch, respectively.

A comparison of Examples 24, 26 and 28 reveals the consistency of the measurement technique for assessment of the calculated effective height per ply under 0.05 psi load at measurement for stacks of 2, 10, and 20 plies in nesting configuration. Those measurements were 0.120 inch, 0.120 inch, and 0.120 inch, respectively. Moreover, a comparison of the variability in the effective height determined for Examples 25, 27, and 29, versus the corresponding determination for Examples 24, 26, and 28, demonstrated that the consistency in measuring height under light load is superior to measurement of height under zero load.

A comparison of Examples 33 and 35 reveals the consistency of measurement of calculated effective height of stacks of 10 and 20 roll-stacked sheets under zero load, with values of 0.158 inch and 154 inch, respectively.

A comparison of Examples 32 and 34 reveals the consistency of measurement of calculated effective height of stacks of 10 and 20 roll-stacked sheets under 0.05 psi load, with values of 0.137 inch and 0.136 inch, respectively. Again, however, the consistency was better for the samples under light load (Examples 32 and 34) than for the examples under zero load (Examples 33 and 35).

The data in Examples 36-43 supports various conclusions for the nesting of CC#2. A comparison of Example 37 with Example 41 demonstrates that under zero load at measurement (but with a temporary loading which was removed before measurement) the single ply of Example 41 exhibited a height of 0.528 inch, which when doubled (1.056 inch) is greater than the measured height (1.005 inch) of two individual plies stacked in nesting relationship of Example 37. The difference indicates a nesting level at zero load of about 4.8 percent.

A comparison of Example 36 with Example 40 demonstrated that under a loading of 0.05 psi at measurement, the single ply of Example 40 exhibited a height of 0.484 inch, which when doubled (0.968 inch) is greater than the measured height (0.908 inch) under 0.05 psi of two individual plies of CC#2 stacked in nesting relationship of Example 36. This difference indicates a nesting level of about 6.2% for the two plies in nesting configuration under 0.05 psi load (Example 36).

A comparison of Example 39 with Example 43 demonstrated that tinder zero load at measurement (but with a temporary loading which was removed before measurement) the stack of 10 sheets of CC#2 in nested configuration of Example 39 had a calculated effective height per ply of 0.504 inch, whereas the roll-stacked sheets of Example 33 had a calculated effective height per ply of 0.513 inch, supporting the conclusion that the plies of Example 39 exhibited a nesting level of about 1.8 percent.

Fourth, a comparison of Example 38 with Example 42 demonstrated that under a load level of 0.05 psi at measurement, the 10 sheets of CC#2 in stacked nested configuration exhibited a calculated effective height per ply of 0.458 inch, whereas the 10 roll-stacked sheets of Example 42 had a calculated effective height per ply of 0.486 inch, supporting the conclusion that the plies of Example 38 exhibited a nesting level of about 5.8 percent.

Although the present invention has been described with reference to the preferred embodiments, it is to be understood that modifications and variations of the invention exist without departing from the principles and scope of the invention, as those skilled in the art will readily understand. Accordingly, such modifications are in accordance with the claims set forth below.

What is claimed is:

1: A fan-folded cellular cushioning article strand comprising an embossed film having a plurality of discrete embossments separated from one another by a land area, with the land area of the embossed film being bonded to a flat backing film with air entrapped within closed chambers between the embossments of the embossed film and the flat backing film, with the embossed film having a land area of from 15 percent to 40 percent, and an embossed area of from 85 percent to 60 percent, with the cellular cushioning article strand being in a fan-fold configuration having a first ply folded against a second ply so that the embossments of the first ply are facing and directly contacting the embossments of the second ply, with the first and second plies in fan-folded configuration having a total height corresponding with a nesting level of at least 1 percent measured by placing the first and second plies in fan-folded configuration under a load of 0.05 psi, relative to the height of roll-stacked first and second plies of the cellular cushioning article under the 0.05 psi load.

2: The fan-folded cellular cushioning article strand according to claim 1, wherein the first and second plies in fan-folded configuration having a total height corresponding with a nesting level of at least 2 percent measured by placing the first and second plies in fan-folded configuration under a load of 0.05 psi, relative to the height of roll-stacked first and second plies of the cellular cushioning article under the 0.05 psi load.

3: The fan-folded cellular cushioning article strand according to claim 1, wherein the first and second plies in fan-folded configuration having a total height corresponding with a nesting level of at least 5 percent measured by placing the first and second plies in fan-folded configuration under a load of 0.05 psi, relative to the height of roll-stacked first and second plies of the cellular cushioning article under the 0.05 psi load.

4: The fan-folded cellular cushioning article strand according to claim 1, wherein the first and second plies in fan-folded configuration having a total height corresponding with a nesting level of at least 10 percent measured by placing the first and second plies in fan-folded configuration under a load of 0.05 psi, relative to the height of roll-stacked first and second plies of the cellular cushioning article under the 0.05 psi load.

5: The fan-folded cellular cushioning article strand according to claim 1, wherein the embossed film has a land area of from 20 to 37 percent and an embossed area of from 63 percent to 80 percent.

6: The fan-folded cellular cushioning article strand according to claim 1, wherein the embossed film has a land area of about 23 percent, and an embossed area of about 77 percent.

7: The fan-folded cellular cushioning article strand according to claim 1, wherein the fan-folded cellular cushioning article strand has from 20 to 40 plies, and the fan-folded cellular cushioning article strand exhibits a nesting level of from 5 percent to 45 percent upon placing the first and second plies under a load of 0.05 psi as measured against the height of a roll-stacked first and second sheets of the cellular cushioning article under a load of 0.05 psi.

8: The fan-folded cellular cushioning article according to claim 1, wherein the embossments comprise a dome surface.

9: The fan-folded cellular cushioning article according to claim 1, wherein the embossments are formed to a substantially hemispherical shape in a substantially hemispherical cavity of a forming chamber, and the embossments have substantially the same diameter.

10: The fan-folded cellular cushioning article according to claim 1, wherein the embossments are arranged in a one-surrounded-by-six pattern.

11: The fan-folded cellular cushioning article according to claim 1, wherein the embossments are arranged in a one-surrounded-by-four pattern.

12: The fan-folded cellular cushioning article according to claim 1, wherein the fan-folded cellular cushioning article is in the form of a stack, and the stack is inside a packaging article.

13: The fan-folded cellular cushioning article according to according to claim 12, wherein the packaging article is a member selected from the group consisting of a box, a bag, and a sleeve.

14: The fan-folded cellular cushioning article strand according to claim 1, wherein at least one member selected from the group consisting of the embossed film and the backing film are perforated along lines across the strand of the cellular cushioning article strand.

15: The fan-folded cellular cushioning article strand according to claim 1, wherein the embossments are arranged in rows across the strand, and adjacent rows have embossments staggered with respect to one another.

16: A cellular cushioning article strand in fan-folded configuration, the cellular cushioning article comprising an embossed film having a plurality of discrete embossments separated from one another by a land area, with the land area of the embossed film being bonded to a flat backing film with air entrapped within closed chambers between the embossments of the embossed film and the flat backing film, with the embossed film having a land area of from 15 percent to 40 percent, and an embossed area of from 85 percent to 60 percent, with the fan-folded cellular cushioning article strand having at least 20 plies in fan-folded configuration with the embossments of the plies facing and in direct contact with one another, with the fan-folded cellular cushioning article exhibiting a nesting level of at least 1 percent upon an uppermost surface of the fan-folded strand being placed under a load of 0.05 psi applied for a time period of 20 seconds with the load then removed for at least 20 seconds to produce a pressed fan-folded strand, with the nesting level being determined at least 20 seconds after the load is removed by comparison of a measured height of the pressed fan-folded strand having 20 plies against a measured height of a corresponding stack of 20 individual plies of the same cellular cushioning article in roll-stacked arrangement placed under the 0.05 psi load applied for the time period of 20 seconds thereafter removed for at least 20 seconds to produce a stack of 20 pressed roll-stacked sheets.

17: The fan-folded cellular cushioning article strand according to claim 1, wherein the first and second plies in fan-folded configuration having a total height corresponding with a nesting level of at least 2 percent, with the nesting level being determined by comparison of a measured height of the pressed fan-folded strand having 20 plies against a measured height of a corresponding stack of 20 individual plies of the same cellular cushioning article in roll-stacked arrangement placed under the 0.05 psi load applied for the time period of 20 seconds thereafter removed to produce a stack of 20 pressed roll-stacked sheets.
